(19) United States
(12) Patent Application Publication
(10) Pub. No.: US 2016/0075213 A1
(43) Pub. Date: Mar. 17, 2016

(54) VEHICLE HEAT MANAGEMENT DEVICE

(71) Applicant: DENSO CORPORATION, Kariya-city, Aichi-pref. (JP)

(72) Inventors: Kengo SUGIMURA, Kariya-city (JP); Nobuharu KAKEHASHI, Toyoake-city (JP); Yoshiki KATOH, Kariya-city (JP); Michio NISHIKAWA, Nagoya-city (JP); Norihiko ENOMOTO, Nagoya-city (JP)

(21) Appl. No.: 14/784,076

(22) PCT Filed: Apr. 14, 2014
(86) PCT No.: PCT/JP2014/002099

§ 371 Date: Oct. 13, 2015

(30) Foreign Application Priority Data
Apr. 22, 2013 (JP) 2013-089454

(51) Int. Cl. B60H 1/32

(52) U.S. Cl. CPC B60H 1/3204

(57) ABSTRACT

A vehicle heat management device applied to a refrigeration cycle includes a pump that suctions and discharges a heat medium, a heat medium cooler that exchanges heat between the heat medium discharged by the pump and low-pressure side refrigerant in the refrigeration cycle to evaporate the low-pressure side refrigerant and to cool the heat medium, a heat medium circulation device through which the heat medium whose heat is exchanged in the heat medium cooler flows and in which the heat medium absorbs heat by its sensible heat change, and a heat medium flow control part that increases a flow rate of the heat medium flowing through the heat medium circulation device when an amount of the heat absorbed by the heat medium in the heat medium circulation device is determined to be larger than a predetermined amount of heat.

### CROSS REFERENCE TO RELATED APPLICATION

This application is based on Japanese Patent Application No. 2013-89454 filed on Apr. 22, 2013, the disclosure of which is incorporated herein by reference.

### TECHNICAL FIELD

The present disclosure relates to a heat management device used for a vehicle.

### BACKGROUND ART

Conventionally, there is widely used an air-conditioning system for a vehicle that cools air blown into a vehicle interior by low-pressure side refrigerant (low-temperature refrigerant) in a refrigeration cycle.

According to this conventional art, an evaporator in a refrigeration cycle exchanges heat between the low-pressure side refrigerant and air blown into a vehicle interior to evaporate the low-pressure side refrigerant and to cool the blown air. Thus, in the evaporator, heat is absorbed from the blown air by a latent heat change of the refrigerant.

This conventional art controls a compressor of the refrigeration cycle such that a flow rate of the refrigerant circulating around the refrigeration cycle increases when a cooling load of the blown air becomes higher. Accordingly, cooling capacity of the blown air is enhanced in accordance with the increase of the cooling load of the blown air.

On the other hand, in Patent Document 1, there is described an air-conditioning system for a vehicle that cools a heat medium by low-pressure side refrigerant (low-temperature refrigerant) in a refrigeration cycle, and that cools the air blown into a vehicle interior using the heat medium cooled by the low-pressure side refrigerant (low-temperature refrigerant) in the refrigeration cycle.

According to this conventional art, an evaporator in the refrigeration cycle exchanges heat between the low-pressure side refrigerant and the heat medium to evaporate the low-pressure side refrigerant and to cool the heat medium. Then, an indoor heat exchanger exchanges heat between the heat medium and the air blown into the vehicle interior to cool the blown air.

In the indoor heat exchanger, even though the heat medium absorbs heat from the blown air, the heat medium does not change its phase, remaining in a liquid phase. Thus, in the indoor heat exchanger, heat is absorbed from the blown air by a sensible heat change of the heat medium.

This conventional art also controls a compressor of the refrigeration cycle such that a flow rate of the refrigerant circulating around the refrigeration cycle increases when a cooling load of the blown air becomes higher. Accordingly, cooling capacity of the blown air is enhanced in accordance with the increase of the cooling load of the blown air.

### PRIOR ART DOCUMENT

### Patent Document

Patent Document 1: JP 2002-96629A

In the former conventional art, heat is absorbed from the blown air by the latent heat change of the refrigerant in the evaporator, while in the latter conventional art, heat is absorbed from the blown air by the sensible heat change of the heat medium in the indoor heat exchanger.

For this reason, in the latter conventional art, if a flow rate of the heat medium flowing through the indoor heat exchanger is maintained constant, when the cooling load of the blown air becomes higher and the amount of heat obtained by the coolant from the blown air while the coolant is flowing through the indoor heat exchanger increases, a temperature distribution of the heat medium in the indoor heat exchanger becomes larger. This is clear from the following mathematical expression F1.

Q=Cp·Gw·(Two−Twi) F1

Q is the amount of heat obtained by the coolant from the blown air while the coolant is flowing through the indoor heat exchanger; Cp is a specific heat of the coolant; Gw is a mass flow rate of the coolant; Two is a temperature of the coolant flowing out of the indoor heat exchanger; and Twi is a temperature of the coolant flowing into the indoor heat exchanger.

Thus, a temperature difference (Two−Twi) between the temperature Two of the coolant flowing out of the indoor heat exchanger and the temperature Twi of the coolant flowing into the indoor heat exchanger increases in proportion to the increase of the amount Q of heat obtained by the coolant from the blown air while the coolant is flowing through the indoor heat exchanger. As a result, the temperature distribution of the blown air heated by the indoor heat exchanger also becomes larger, thereby impairing an occupant's air-conditioning feeling.

In the latter conventional art, when the cooling load of the blown air becomes lower and the amount Q of heat obtained by the coolant from the blown air while the coolant is flowing through the indoor heat exchanger is reduced, the temperature difference (Two−Twi) between the temperature Two of the coolant flowing out of the indoor heat exchanger and the temperature Twi of the coolant flowing into the indoor heat exchanger becomes smaller than necessary. In other words, the mass flow rate Gw of the coolant becomes excessive relative to the cooling load, with the result that the power for circulating the coolant is excessively consumed.

This issue occurs not only in the indoor heat exchanger but also similarly in a heat medium circulation device (e.g., battery cooling unit for cooling a battery) in which the heat medium absorbs heat by the sensible heat change.

### SUMMARY OF INVENTION

The present disclosure addresses the above issues. Thus, it is an objective of the present disclosure to limit a temperature distribution of a heat medium in a heat medium circulation device.

The present disclosure addresses the above issues. Thus, it is another objective of the present disclosure to reduce power consumed to circulate a heat medium.

To achieve the objective of the present disclosure, in a first aspect of the present disclosure, a vehicle heat management device applied to a refrigeration cycle includes a pump that suctions and discharges a heat medium, a heat medium cooler that exchanges heat between the heat medium discharged by the pump and low-pressure side refrigerant in the refrigeration cycle to evaporate the low-pressure side refrigerant and to cool the heat medium, a heat medium circulation device through which the heat medium whose heat is exchanged in the heat medium cooler flows and in which the heat medium absorbs heat by its sensible heat change, and a heat medium flow control part that increases a flow rate of the heat medium flowing through the heat medium circulation device when an amount of the heat absorbed by the heat medium in the heat medium circulation device is determined to be larger than a predetermined amount of heat.

Accordingly, when the amount of heat absorbed by the heat medium in the heat medium circulation device is determined to be larger than a predetermined amount of heat, the flow rate of the heat medium flowing through the heat medium circulation device is increased. As a result, as is evident from the above mathematical expression F1, a temperature difference obtained by subtracting the temperature of the heat medium flowing into the heat medium circulation device from the temperature of the heat medium flowing out of the heat medium circulation device can be reduced. Consequently, a temperature distribution of the heat medium in the heat medium circulation device can be limited.

To achieve the another objective of the present disclosure, in a second aspect of the present disclosure, a vehicle heat management device applied to a refrigeration cycle, includes a heat medium cooler that exchanges heat between low-pressure side refrigerant in the refrigeration cycle and a heat medium to evaporate the low-pressure side refrigerant and to cool the heat medium, a heat medium circulation device through which the heat medium whose heat is exchanged in the heat medium cooler flows and in which the heat medium absorbs heat by its sensible heat change, and a heat medium flow control part that decreases a flow rate of the heat medium flowing through the heat medium circulation device when an amount of the heat absorbed by the heat medium in the heat medium circulation device is determined to be smaller than a predetermined amount of heat.

Accordingly, when the amount of heat absorbed by the heat medium in the heat medium circulation device is determined to be smaller than a predetermined amount of heat, the flow rate of the heat medium flowing through the heat medium circulation device is decreased. As a result, excessive use of the power for circulating the heat medium as a result of the excessive flow rate of the heat medium flowing through the heat medium circulation device relative to the amount of heat absorbed by the heat medium in the heat medium circulation device, can be restricted. Thus, the power consumed to circulate the heat medium can be reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an entire configuration of a vehicle heat management device in accordance with a first embodiment;

FIG. 2 is a sectional view illustrating a vehicle interior air-conditioning unit according to the first embodiment;

FIG. 3 is a control map used in blower level determination processing performed by a control device according to the first embodiment;

FIG. 4 is a control map used in the blower level determination processing performed by the control device of the first embodiment;

FIG. 5 is a control map used in the blower level determination processing performed by the control device of the first embodiment;

FIG. 6 is a control map used in the blower level determination processing performed by the control device of the first embodiment;

FIG. 7 is a diagram illustrating the amount of heat given to coolant by blown air in a cooler core according to the first embodiment;

FIG. 8 is a control map used in coolant flow determination processing performed by the control device of the first embodiment;

FIG. 9 is a control map used in the coolant flow determination processing performed by the control device of the first embodiment; and

FIG. 10 is a control map used in coolant flow determination processing performed by a control device in accordance with a second embodiment.

### EMBODIMENTS FOR CARRYING OUT INVENTION

Embodiments will be described below in reference to the drawings. For the same or equivalent component in the following embodiments, the same or corresponding reference numeral is used in the drawings.

### First Embodiment

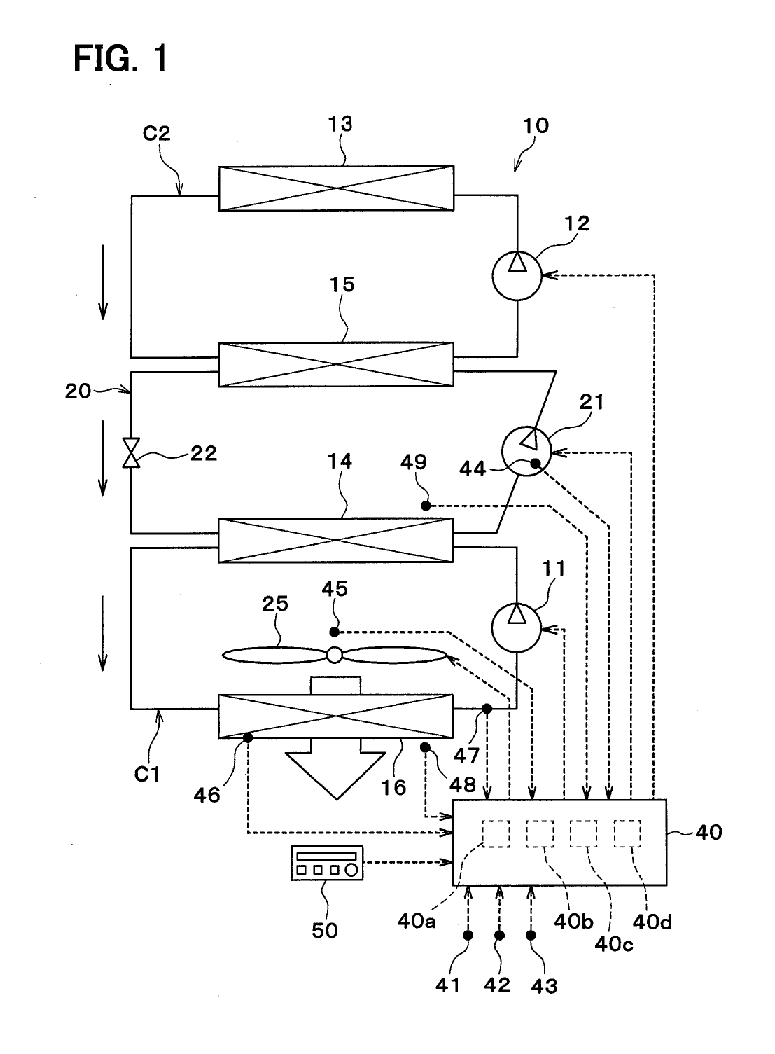

A first embodiment will be explained below with reference to FIGS. 1 to 9. A vehicle heat management device 10 illustrated in FIG. 1 is used for adjusting various apparatuses of a vehicle or the vehicle interior to an appropriate temperature. In the present embodiment, the vehicle heat management device 10 is applied to a hybrid automobile that obtains driving force for vehicle traveling from an engine (internal combustion engine) and an electric motor for traveling.

The hybrid automobile of the present embodiment is configured as a plug-in hybrid automobile that can charge a battery disposed in the vehicle (in-vehicle battery) with the electric power supplied from an external power source (commercial power source) while the vehicle is stopped. For example, a lithium ion battery can be used as the battery.

The driving force outputted from the engine is used not only for vehicle traveling but also for operating a generator. The electric power generated by the generator and the electric power supplied from the external power source can be stored in the battery. The electric power stored in the battery is supplied not only to the electric motor for traveling but also to various in-vehicle devices such as the electric component devices constituting the vehicle heat management device 10.

As illustrated in FIG. 1, the vehicle heat management device 10 includes a first pump 11, a second pump 12, a radiator 13, a coolant cooler 14, a coolant heater 15, and a cooler core 16.

The first pump 11 and the second pump 12 are electric pumps that suction or discharge coolant (heat medium). The coolant is fluid serving as a heat medium. In the present embodiment, liquid including at least ethylene glycol, dimethylpolysiloxane, or nano fluid, or antifreeze liquid is used as the coolant.

The radiator 13, the coolant cooler 14, the coolant heater 15, and the cooler core 16 are coolant circulation devices (heat medium circulation devices) through which the coolant flows.

The radiator 13 is a heat radiator (heat medium outside air heat exchanger) that exchanges heat between the coolant and outside air (air outside the vehicle compartment) to release the heat of the coolant into the outside air. The outside air is blown to the radiator 13 by a blower (not shown) outside the vehicle compartment. The radiator 13 and the blower outside the vehicle compartment are arranged at the frontmost part of the vehicle. Accordingly, traveling wind can be applied to the radiator 13 while the vehicle is traveling.

The coolant cooler 14 is a low-pressure side heat exchanger (heat medium cooler) that exchanges heat between low-pressure side refrigerant in a refrigeration cycle 20 and the coolant to cool the coolant. The coolant cooler 14 can cool the coolant to a temperature that is lower than the temperature of the outside air.

The coolant heater 15 is a high-pressure side heat exchanger (refrigerant cooler) that exchanges heat between high-pressure side refrigerant in the refrigeration cycle 20 and the coolant to cool the high-pressure side refrigerant.

The refrigeration cycle 20 is a vapor compression type refrigerator including a compressor 21, the coolant heater 15, an expansion valve 22, and the coolant cooler 14. In the refrigeration cycle 20 of the present embodiment, fluorocarbon refrigerant is used as the refrigerant. The refrigeration cycle 20 is configured as a subcritical refrigeration cycle in which the pressure of the high-pressure side refrigerant does not exceed the critical pressure of the refrigerant.

The compressor 21 is an electric compressor that is driven by the electric power supplied from the battery or a variable capacity type compressor that is driven by a belt, and draws in, compresses, and discharges the refrigerant in the refrigeration cycle 20. The coolant heater 15 is a condenser that exchanges heat between the high-pressure side refrigerant discharged from the compressor 21 and the coolant to condense the high-pressure side refrigerant.

The expansion valve 22 is a pressure-reducing means that depressurizes and expands the liquid-phase refrigerant flowing out of the coolant heater 15. The coolant cooler 14 is an evaporator that exchanges heat between the low-pressure refrigerant depressurized and expanded by the expansion valve 22 and the coolant to evaporate the low-pressure refrigerant. The gas-phase refrigerant evaporated by the coolant cooler 14 is drawn into the compressor 21 to be compressed.

The cooler core 16 is a heat exchanger for cooling (air cooler) that exchanges heat between the coolant and the air blown into the vehicle interior to cool the air blown into the vehicle interior. In the cooler core 16, the coolant absorbs heat from the blown air by its sensible heat change. Thus, in the cooler core 16, the coolant does not change its phase, remaining in a liquid phase even though the coolant absorbs heat from the blown air. Inside air, outside air, or mixed air of inside air and outside air is blown to the cooler core 16 by a vehicle interior blower 25.

The first pump 11, the coolant cooler 14, and the cooler core 16 are arranged in a first coolant circuit C1 (first heat medium circuit). The first coolant circuit C1 is configured such that the coolant (first heat medium) circulates in the order of first pump 11->coolant cooler 14->cooler core 16->first pump 11.

The second pump 12, the radiator 13, and the coolant heater 15 are arranged in a second coolant circuit C2 (second heat medium circuit). The second coolant circuit C2 is configured such that the coolant (second heat medium or another heat medium) circulates in the order of second pump 12->radiator 13->coolant heater 15->second pump 12.

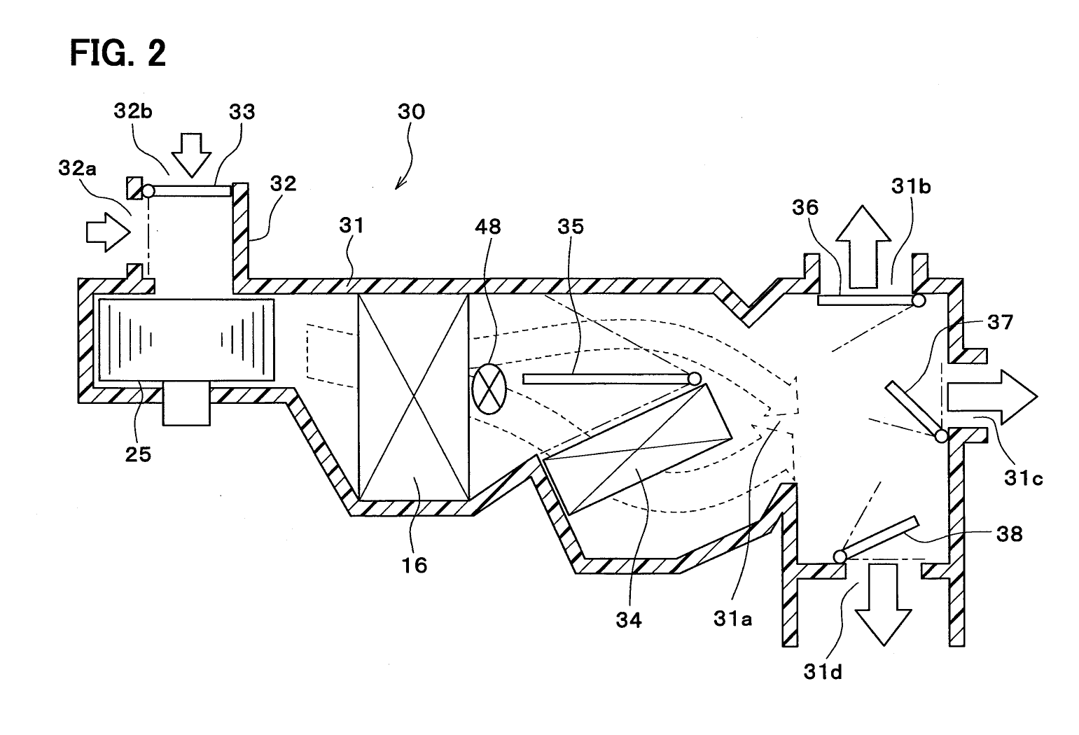

As illustrated in FIG. 2, the cooler core 16 and the vehicle interior blower 25 are accommodated in a casing 31 of a vehicle interior air-conditioning unit 30 of an air-conditioning system for the vehicle. The vehicle interior air-conditioning unit 30 is disposed inside an instrument panel at the frontmost part of the vehicle interior. The casing 31 is configured as an outer shell of the vehicle interior air-conditioning unit 30.

The casing 31 defines an air passage for vehicle interior blown air which is blown into the vehicle interior. The casing 31 has a certain degree of resiliency and is shaped from resin (e.g., polypropylene) which is also excellent in strength.

An inside/outside air switching device 32 is disposed on the most upstream side in a flow direction of the vehicle interior blown air in the casing 31. The inside/outside air switching device 32 is an inside/outside air introducing means that introduces switchingly vehicle interior air (inside air) or outside air into the casing 31.

An inside air introduction port 32a and an outside air introduction port 32b are formed at the inside/outside air switching device 32. The inside air introduction port 32a is an inside air introducing means that introduces the inside air into the casing 31. The outside air introduction port 32b is an outside air introducing means that introduces the outside air into the casing 31.

An inside/outside air switch door 33 is disposed inside the inside/outside air switching device 32. The inside/outside air switch door 33 is an inside/outside air switching means that adjusts the opening areas of the inside air introduction port 32a and the outside air introduction port 32b to change an air volume ratio between the air volume of inside air and the air volume of outside air.

The vehicle interior blower 25 is disposed in the casing 31 on a downstream side of the inside/outside air switching device 32 in an air flow direction. The vehicle interior blower 25 is a blowing means that blows air toward the vehicle interior. The vehicle interior blower 25 is an electric blower that drives a centrifugal multiblade fan (sirocco fan) by an electric motor (blower motor).

The cooler core 16 is disposed in the casing 31 on a downstream side of the vehicle interior blower 25 in the air flow direction. A heater core 34 is disposed in the casing 31 on a downstream side of the cooler core 16 in the air flow direction. The heater core 34 is a heat exchanger for heating that exchanges heat between engine coolant and the vehicle interior blown air to heat the vehicle interior blown air.

An air mix door 35 is disposed in the casing 31 on a downstream side of the cooler core 16 in the air flow direction and on an upstream side of the heater core 34 in the air flow direction. The air mix door 35 is an air volume ratio adjusting means that adjusts a volume ratio of air passing through the heater core 34 to the blown air after passing through the cooler core 16. The air mix door 35 is driven, for example, by a servomotor (not shown).

A mixing space 31a, in which the blown air that is heated after heat exchange with the refrigerant in the heater core 34, and the blown air that bypasses the heater core 34 and is thereby not heated by the heater core 34 are mixed together, is provided in the casing 31 on a downstream side of the heater core 34 in the air flow direction.

A defroster opening 31b, a face opening 31c, and a foot opening 31d are formed at the most downstream part of the casing 31 in the air flow direction. The defroster opening 31b, the face opening 31c, and the foot opening 31d are blowing-out means that blows out the air-conditioned wind mixed in the mixing space 31a into the vehicle interior which is a cooling-object space. The defroster opening 31b is an opening for blowing out the air-conditioned wind toward an inner surface of a windshield at the front of the vehicle. The face opening 31c is an opening for blowing out the air-conditioned wind toward a vehicle occupant's upper body in the vehicle interior. The foot opening 31d is an opening for blowing out the air-conditioned wind toward the occupant's feet.

A downstream side of the defroster opening 31b in the air flow direction is connected to a defroster blow-out port (not shown) which is provided in the vehicle interior through a duct defining the air passage. A downstream side of the face opening 31c in the air flow direction is connected to a face blow-out port (not shown) which is provided in the vehicle interior through a duct defining the air passage. A downstream side of the foot opening 31d in the air flow direction is connected to a foot blow-out port (not shown) which is provided in the vehicle interior through a duct defining the air passage.

By adjusting a volume ratio of air passing through the heater core 34 by the air mix door 35, the temperature of the air-conditioned wind mixed in the mixing space 31a is adjusted, and the temperature of the air-conditioned wind blown out of the openings 31b, 31c, 31d is adjusted. Thus, the air mix door 35 is a temperature regulating means that adjusts the temperature of air-conditioned wind which is blown into the vehicle interior.

A defroster door 36 is disposed in the casing 31 on an upstream side of the defroster opening 31b in the air flow direction. The defroster door 36 is a defroster opening area adjusting means that adjusts an opening area of the defroster opening 31b.

A face door 37 is disposed in the casing 31 on an upstream side of the face opening 31c in the air flow direction. The face door 37 is a face opening area adjusting means that adjusts an opening area of the face opening 31c.

A foot door 38 is disposed in the casing 31 on an upstream side of the foot opening 31d in the air flow direction. The foot door 38 is a foot opening area adjusting means that adjusts an opening area of the foot opening 31d.

The defroster door 36, the face door 37, and the foot door 38 are blow-out mode switching means that switches between blow-out modes, and are driven by the servomotor (not shown) via a link mechanism or the like.

A blown-out port mode switched by the defroster door 36, the face door 37, and the foot door 38 may be a face mode, a bi-level mode, a foot mode, a foot defroster mode, or a defroster mode.

The face mode is a blown-out port mode in which to fully open the face blow-out port, thereby blowing out the air from the face blow-out port toward the occupant's upper body in the vehicle interior. The bi-level mode is a blown-out port mode in which to open both the face blow-out port and the foot blow-out port, thereby blowing out the air toward the occupant's upper body and feet in the vehicle interior.

The foot mode is a blown-out port mode in which to fully open the foot blow-out port and to open the defroster blow-out port by its small opening degree, thereby blowing out the air mainly from the foot blow-out port. The foot defroster mode is a blown-out port mode in which to open the foot blow-out port and the defroster blow-out port in the same degree, thereby blowing out the air from both the foot blow-out port and the defroster blow-out port.

The defroster mode is a blown-out port mode in which to fully open the defroster blow-out port, thereby blowing out the air from the defroster air outlet onto the inner surface of the windshield at the vehicle front.

A control device 40 is configured by a widely-known microcomputer including a CPU, a ROM, and a RAM, and its peripheral circuit. The control device 40 is a control means that performs various calculations and processings based on an air-conditioning control program stored in the ROM to control the operations of the first pump 11, the second pump 12, the compressor 21, the vehicle interior blower 25 and so forth connected to the output side.

The control device 40 is a device with which the control means that controls various control object devices connected to its output side is integrally configured. The configuration (hardware and software) that controls the operation of each control object device serves as a control means that controls the operation of each control object device.

The configuration (hardware and software) of the control device 40 that controls the operation of the first pump 11 serves as a first coolant flow control means 40a ((first) heat medium flow control part). The coolant flow control means 40a may be configured separately from the control device 40. The configuration (hardware and software) of the control device 40 that controls the operation of the second pump 12 serves as a second coolant flow control means 40b (second heat medium flow control part, or another heat medium flow control part). The second coolant flow control means 40b may be configured separately from the control device 40.

The configuration (hardware and software) of the control device 40 that controls the operation of the compressor 21 serves as a refrigerant flow control part 40c. The refrigerant flow control part 40c may be configured separately from the control device 40.

The configuration (hardware and software) of the control device 40 that controls the operation of the vehicle interior blower 25 serves as an air flow control part 40d. The air flow control part 40d may be configured separately from the control device 40.

Detection signals from a sensor group including an inside air sensor 41, an outside air sensor 42, an insolation sensor 43, a compressor rotation speed sensor 44, a blower voltage sensor 45, a cooler core inlet coolant temperature sensor 46, a cooler core outlet coolant temperature sensor 47, a cooler core blown-out air temperature sensor 48, and a coolant cooler blown-out air temperature sensor 49 are inputted into the input side of the control device 40.

The inside air sensor 41 is a detecting means (inside air temperature detecting means) that detects inside air temperature (vehicle interior temperature). The outside air sensor 42 is a detecting means (outside air temperature detecting means) that detects outside air temperature (temperature outside the vehicle compartment). The insolation sensor 43 is a detecting means (insolation amount detecting means) that detects the amount of insolation in the vehicle interior.

The compressor rotation speed sensor 44 is a detecting means (rotation speed detecting means) that detects a rotation speed of the compressor 21. The blower voltage sensor 45 is a detecting means (voltage detecting means) that detects a voltage value of the electric motor of the vehicle interior blower 25.

The cooler core inlet coolant temperature sensor 46 is a detecting means (inlet heat medium temperature detecting means) that detects coolant temperature at a coolant inlet part of the cooler core 16. The cooler core outlet coolant temperature sensor 47 is a detecting means (outlet heat medium temperature detecting means) that detects coolant temperature at a coolant outlet part of the cooler core 16.

The cooler core blown-out air temperature sensor 48 is a detecting means (outlet air temperature detecting means) that detects blown-out air temperature of the cooler core 16. The coolant cooler blown-out air temperature sensor 49 is a detecting means (outlet air temperature detecting means) that detects blown-out air temperature of the coolant cooler 14.

The inside air temperature, the outside air temperature, the insolation amount, the compressor rotation speed, the blower voltage value, the cooler core inlet coolant temperature, the cooler core outlet coolant temperature, the cooler core blown-out air temperature, and the coolant cooler blown-out air temperature may be estimated based on the detection values of the various physical amounts.

Various air-conditioning operation signals from operating members of an air-conditioning operation panel 50 are inputted into the input side of the control device 40. The air-conditioning operation panel 50 is disposed near the instrument panel in the vehicle interior. A temperature setting switch for setting a set temperature in the vehicle interior, an air-conditioning switch for switching between the activation and stop of the compressor 21, an air volume changeover switch for switching the air volume of the vehicle interior blower 25 and so forth are provided for the air-conditioning operation panel 50.

The operation will be explained below based on the above-described configuration. When the control device 40 activates the first pump 11, the second pump 12, the compressor 21, the vehicle interior blower 25 and so forth, the refrigerant circulates through the refrigeration cycle 20, the coolant circulates through the first coolant circuit C1, and the coolant circulates through the second coolant circuit C2.

At the coolant cooler 14, the refrigerant in the refrigeration cycle 20 absorbs heat from the coolant in the first coolant circuit C1, so that the coolant in the first coolant circuit C1 is cooled. The refrigerant in the refrigeration cycle 20, which has absorbed heat from the coolant in the first coolant circuit C1 at the coolant cooler 14, releases the heat into the coolant in the second coolant circuit C2 at the coolant heater 15. Accordingly, the coolant in the second coolant circuit C2 is heated. The coolant in the second coolant circuit C2, into which the heat has been released from the refrigerant in the refrigeration cycle 20 at the coolant heater 15 and which has thereby been heated, releases the heat into the outside air at the radiator 13.

The coolant in the first coolant circuit C1, which has been cooled at the coolant cooler 14, absorbs heat from the air blown into the vehicle interior at the cooler core 16. Accordingly, the air blown into the vehicle interior is cooled at the cooler core 16.

The control device 40 determines a blown-in port mode based on a target blown-out temperature TAO of the air blown out to the vehicle interior. The blown-in port mode is a switching state of the inside/outside air switch door 33.

The target blown-out temperature TAO is calculated by the following mathematical expression F2.

TAO=Kset×Tset−Kr×Tr−Kam×Tam−Ks×Ts+C F2

Tset is a vehicle interior set temperature set by a vehicle interior temperature setting switch, Tr is the vehicle interior temperature (inside air temperature) detected by the inside air sensor 41, Tam is the outside air temperature detected by the outside air sensor 42, and Ts is the insolation amount detected by the insolation sensor 43. Kset, Kr, Kam, Ks are control gains, and C is a constant for correction.

The target blown-out temperature TAO corresponds to the amount of heat that needs to be produced by the vehicle air-conditioning system for maintaining the vehicle interior at a desired temperature, and can be regarded as an air-conditioning heat load (refrigerated air-conditioning load and heating load) required for the vehicle air-conditioning system. Thus, when the refrigerated air-conditioning load required for the vehicle air-conditioning system is high, the target blown-out temperature TAO is in a low-temperature region, and when the heating load required for the vehicle air-conditioning system is high, the target blown-out temperature TAO is in a high-temperature region.

As a blown-in port mode, the control device 40 preferentially selects an outside air mode in which to basically introduce the outside air. However, for example, when the target blown-out temperature TAO is in an extremely low-temperature region and high refrigerated air-conditioning performance needs to be achieved, the control device 40 selects an inside air mode in which to introduce the inside air.

The control device 40 determines the blown-out port mode based on the target blown-out temperature TAO. The blown-out port mode is a switching state between the face door 37, the foot door 38, and the defroster door 36.

For example, as the target blown-out temperature TAO increases from a low-temperature region to a high-temperature region, the blown-out port mode is switched sequentially: face mode->bi-level mode->foot mode. Therefore, the face mode mainly tends to be selected during summer, the bi-level mode mainly tends to be selected during spring and autumn, and the foot mode mainly tends to be selected during winter.

The control device 40 determines a blowing capacity of the vehicle interior blower 25 (specifically, voltage applied to the electric motor of the vehicle interior blower 25) as follows.

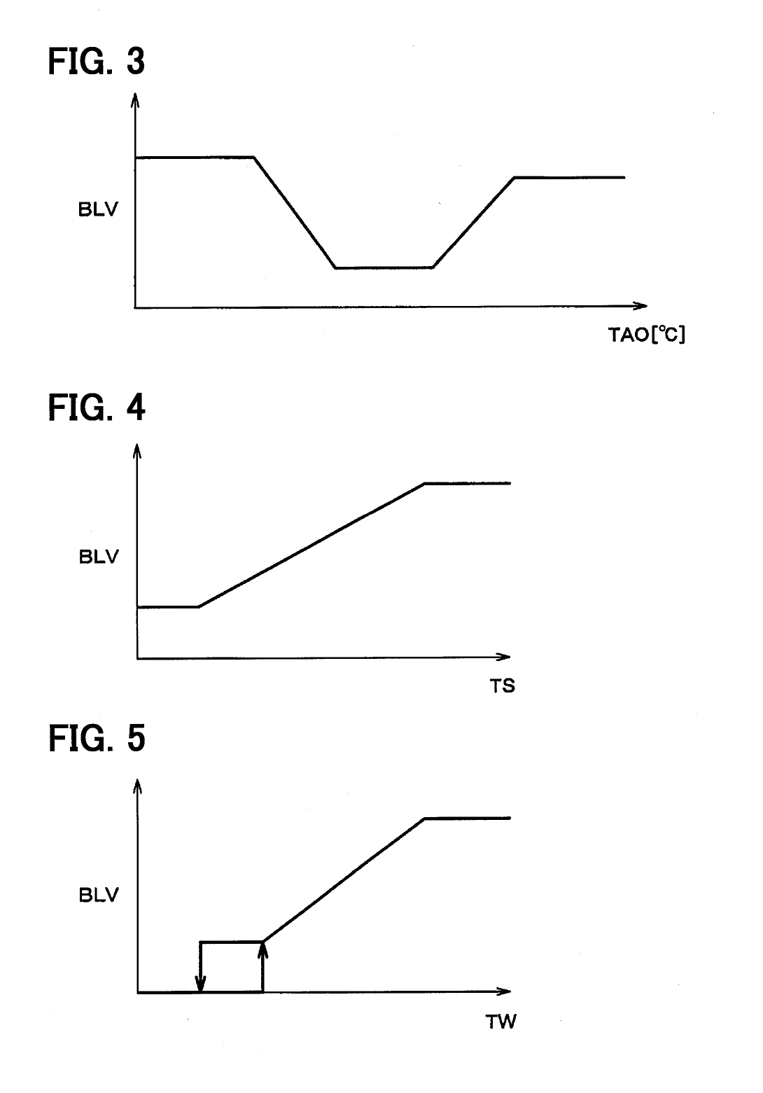

First, the control device 40 determines a blower level BLV in reference to a control map illustrated in FIG. 3. The control map in FIG. 3 is stored in the control device 40 beforehand. The control map is configured such that the value of the blower level BLV relative to the target blown-out temperature TAO of the air blown out to the vehicle interior draws a curved line in a bathtub-shape.

Specifically, in a low-temperature region and a high-temperature region of the target blown-out temperature TAO, the blower level BLV is increased to a high level so that the air volume of the vehicle interior blower 25 reaches approximately the maximum air volume. When the target blown-out temperature TAO increases from the low-temperature region to an intermediate-temperature region, the blower level BLV is decreased such that the volume of air blown by the vehicle interior blower 25 is reduced in accordance with the increase of the target blown-out temperature TAO. When the target blown-out temperature TAO decreases from the high-temperature region to the intermediate-temperature region, the blower level BLV is decreased such that the air volume of the vehicle interior blower 25 is reduced in accordance with the decrease of the target blown-out temperature TAO. When the target blown-out temperature TAO enters into the intermediate-temperature region, the blower level BLV is decreased to a low level so that the air volume of the vehicle interior blower 25 reaches the minimum air volume. Accordingly, the blower level BLV is calculated according to the air-conditioning heat load.

As described above, the blower level BLV is a value determined based on the target blown-out temperature TAO. In other words, the blower level BLV is determined based on a value, which is determined based on the vehicle interior set temperature Tset, the inside air temperature Tr, the outside air temperature Tam, and the insolation amount Ts.

Then, the control device 40 determines a blower voltage (blower motor voltage) based on the determined blower level BLV. Specifically, the control device 40 increases the blower voltage in accordance with the increase of the blower level BLV, and decreases the blower voltage in accordance with the decrease of the blower level BLV.

When the blown-out port mode is the face mode or bi-level mode, the control device 40 makes an insolation correction to the blower level BLV with reference to a control map illustrated in FIG. 4.

Specifically, in a region where the insolation amount Ts detected by the insolation sensor 43 is small, the blower level BLV is decreased to a low level. In a region where the insolation amount Ts is large, the blower level BLV is increased to a high level. When the insolation amount Ts increases from the region of the small insolation amount Ts to the region of the large insolation amount Ts, the blower level BLV is increased in accordance with the increase of the insolation amount Ts.

Following this, a larger value is selected by comparison between the value of the blower level BLV determined based on the insolation amount Ts, and the value of the blower level BLV determined based on the target blown-out temperature TAO.

Accordingly, the blowing capacity (volume of blown air) of the vehicle interior blower 25 can be made large when the insolation amount is large. As a result, the occupant's refrigerated air-conditioning feeling can be improved.

At the time of warming-up shortly after the engine is started up, the control device 40 makes a warm-up correction to the blower level BLV based on a control map illustrated in FIG. 5.

Specifically, the blower level BLV is decreased to a low level in a low-temperature region of engine coolant temperature TW, and the blower level BLV is increased to a high level in a high-temperature region of the engine coolant temperature TW. When the engine coolant temperature TW increases from the low-temperature region to the high-temperature region, the blower level BLV is increased in accordance with the increase of the engine coolant temperature TW. A hysteresis width for preventing control hunting is set on the control map in FIG. 5.

Next, a smaller value is selected by comparison between the value of the blower level BLV determined based on the engine coolant temperature TW, and the value of the blower level BLV determined based on the target blown-out temperature TAO.

Accordingly, at the time of warming-up when the engine coolant temperature TW is not sufficiently high, the blowing capacity (volume of blown air) of the vehicle interior blower 25 can be made small, and thus the occupant's coldness feeling can be restricted from being made stronger as a result of the blown-out air which is not sufficiently heated.

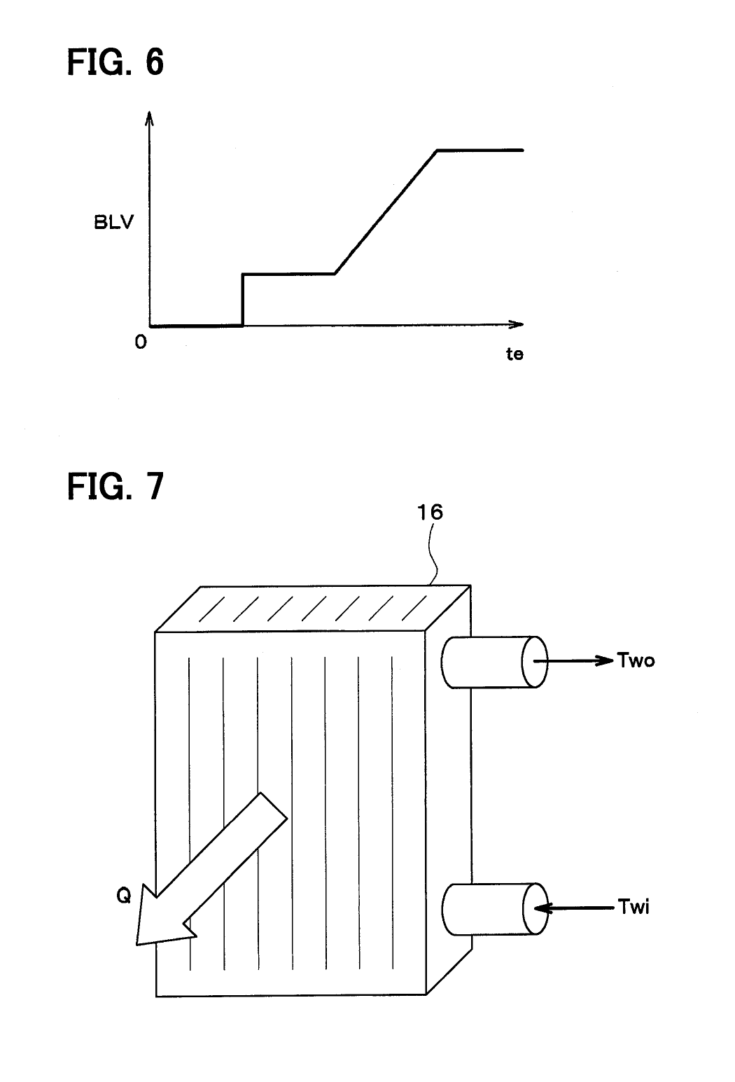

At the time of cooling-down (immediately after refrigerated air-conditioning is started) during summer, the control device 40 makes a cool-down correction to the blower level BLV in reference to a control map illustrated in FIG. 6.

Specifically, when the refrigerated air-conditioning is started, the blower level BLV is first set to zero, and then the blower level BLV is decreased to a low level. Furthermore, after that, the blower level BLV is increased according to an elapsed time te after the refrigerated air-conditioning is started.

Subsequently, a smaller value is selected by comparison between the value of the blower level BLV determined based on the elapsed time te after the refrigerated air-conditioning is started, and the value of the blower level BLV determined based on the target blown-out temperature TAO.

Accordingly, at the time of cooling-down when the blown-out air temperature is not sufficiently low, the blowing capacity (volume of blown air) of the vehicle interior blower 25 can be made small, and thus the occupant's hotness feeling can be restricted from being made stronger as a result of the blown-out air which is not sufficiently cooled.

The control device 40 determines a refrigerant discharge capacity of the compressor 21 (specifically, the rotation speed of the compressor 21) based on a difference (TEO−TE) between a target blown-out temperature TEO and a blown-out air temperature TE of the coolant cooler 14. Specifically, the refrigerant discharge capacity of the compressor 21 is determined such that the blown-out air temperature TE approaches the target blown-out temperature TEO.

Accordingly, when the refrigerated air-conditioning load increases, the blown-out air temperature TE increases and the difference (TEO−TE) between the target blown-out temperature TEO and the blown-out air temperature TE also increases. Thus, the rotation speed Nc of the compressor 21 is increased.

The target blown-out temperature TEO is set at, for example, 2° C. to prevent attachment of frost on the coolant cooler 14.

As illustrated in FIG. 7, the amount Q of heat is given to coolant in the cooler core 16 from the blown air. This amount Q of heat is calculated by the above mathematical expression F1.

The control device 40 determines a coolant discharge capacity of the first pump 11 (specifically, the rotation speed of the first pump 11) in accordance with the physical quantity related to the amount Q of heat given to coolant in the cooler core 16 from the blown air.

In other words, the control device 40 determines the coolant discharge capacity of the first pump 11 (specifically, the rotation speed of the first pump 11) in accordance with the physical quantity related to the cooling load of the blown air at the cooler core 16.

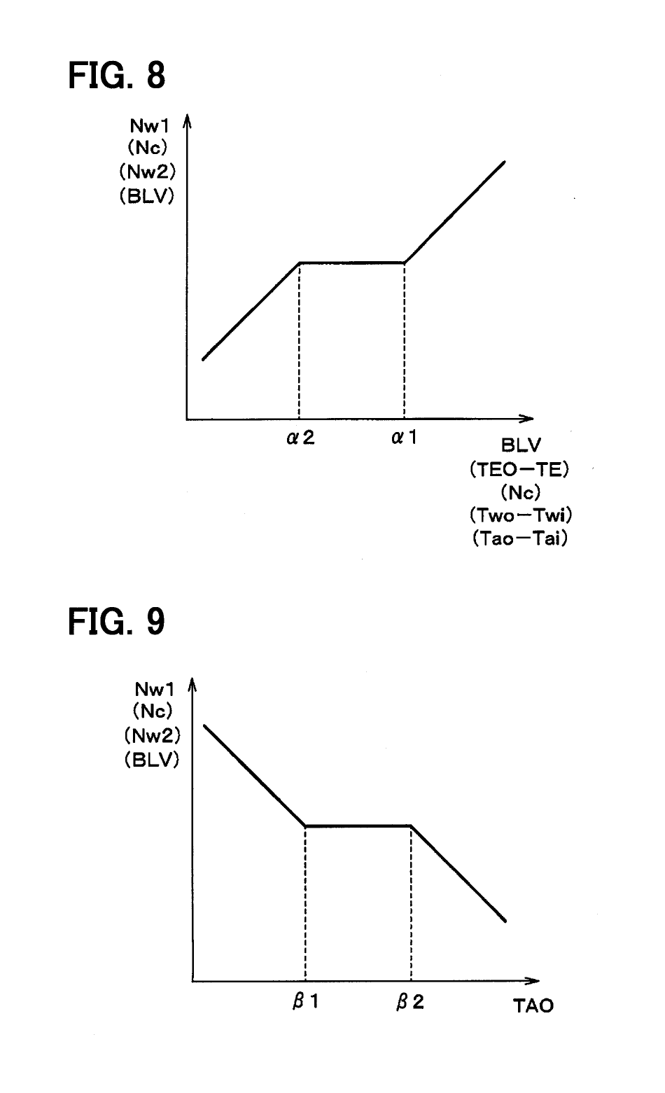

More specifically, the control device 40 determines the rotation speed of the first pump 11 with reference to control maps illustrated in FIGS. 8 and 9.

As illustrated in FIG. 8, when the blower level BLV (blowing capacity of the vehicle interior blower 25) is larger than a first predetermined value α1, the rotation speed Nw1 of the first pump 11 is increased in accordance with the increase of the blower level BLV. Accordingly, the flow rate of the coolant flowing through the cooler core 16 increases.

On the other hand, when the blower level BLV is smaller than a second predetermined value α2, the rotation speed Nw1 of the first pump 11 is decreased in accordance with the decrease of the blower level BLV. Accordingly, the flow rate of the coolant flowing through the cooler core 16 decreases.

The first predetermined value α1 and the second predetermined value α2 are stored beforehand in the control device 40. The second predetermined value α2 is a value that is smaller than the first predetermined value α1.

As indicated in parentheses along the horizontal axis in FIG. 8, instead of the blower level BLV, the rotation speed Nw1 of the first pump 11 may be determined based on the difference (TEO−TE) between the target blown-out temperature TEO and the blown-out air temperature TE of the coolant cooler 14, the rotation speed Nc of the compressor 21, a coolant inlet/outlet temperature difference (Two−Twi) of the cooler core 16, or an air inlet/outlet temperature difference (Tao−Tai) of the cooler core 16.

The coolant inlet/outlet temperature difference (Two−Twi) of the cooler core 16 is a temperature difference obtained by subtracting the temperature Twi of the coolant flowing into the cooler core 16 from the temperature Two of the coolant flowing out of the cooler core 16.

The temperature Two of the coolant flowing out of the cooler core 16 is a temperature detected by the cooler core outlet coolant temperature sensor 47. The temperature Twi of the coolant flowing into the cooler core 16 is a temperature detected by the cooler core inlet coolant temperature sensor 46.

The air inlet/outlet temperature difference (Tao−Tai) of the cooler core 16 is a temperature difference obtained by subtracting the temperature Tai of the blown air flowing into the cooler core 16 from the temperature Tao of the blown air flowing out of the cooler core 16.

The temperature Tao of the blown air flowing out of the cooler core 16 is a temperature detected by the cooler core blown-out air temperature sensor 48. The temperature Tai of the blown air flowing into the cooler core 16 is a temperature calculated from the inside air temperature that is detected by the inside air sensor 41, the outside air temperature that is detected by the outside air sensor 42, and the air volume ratio between the inside air and outside air that is adjusted by the inside/outside air switch door 33.

As illustrated in FIG. 9, when the target blown-out temperature TAO is smaller than a first predetermined value β1, the rotation speed Nw1 of the first pump 11 is increased in accordance with the decrease of the target blown-out temperature TAO. Accordingly, the flow rate of the coolant flowing through the cooler core 16 increases.

On the other hand, when the target blown-out temperature TAO is larger than a second predetermined value β2, the rotation speed Nw1 of the first pump 11 is decreased in accordance with the increase of the target blown-out temperature TAO. Accordingly, the flow rate of the coolant flowing through the cooler core 16 decreases.

The first predetermined value β1 and the second predetermined value β2 are stored beforehand in the control device 40. The second predetermined value β2 is a value that is larger than the first predetermined value β1.

As indicated in parentheses along the vertical axes in FIGS. 8 and 9, when the flow rate of the coolant flowing through the cooler core 16 is increased by increasing the rotation speed Nw1 of the first pump 11, the rotation speed Nc of the compressor 21, a rotation speed Nw2 of the second pump 12, and the blower level BLV may also be increased.

In the present embodiment, when the amount Q of heat absorbed by the coolant in the cooler core 16 is determined to be larger than a predetermined amount of heat, the flow rate of the coolant flowing through the cooler core 16 is increased. Accordingly, as is evident from the above mathematical expression F1, the temperature difference (Two−Twi) obtained by subtracting the temperature Twi of the coolant flowing into the cooler core 16 from the temperature Two of the coolant flowing out of the cooler core 16 can be reduced. As a result, a temperature distribution of the coolant in the cooler core 16 can be limited.

In the present embodiment, when the amount Q of heat absorbed by the coolant in the cooler core 16 is determined to be smaller than a predetermined amount of heat, the flow rate of the coolant flowing through the cooler core 16 is decreased. Accordingly, excessive use of the power for circulating the coolant as a result of the excessive flow rate of the coolant flowing through the cooler core 16 relative to the amount Q of heat absorbed by the coolant in the cooler core 16, can be restricted.

In the present embodiment, the control device 40 (coolant flow control means 40a) controls the flow rate of the coolant in accordance with the physical quantity related to the cooling load of the blown air at the cooler core 16. Accordingly, the restriction of the temperature distribution of the coolant in the cooler core 16 and the reduction of the power for circulating the coolant by appropriately controlling the flow rate of the coolant can be both achieved.

For example, the physical quantity related to the flow rate of blown air flowing through the cooler core 16, such as the blower level BLV, can be used as the physical quantity related to the cooling load of the blown air at the cooler core 16.

For example, the physical quantity related to the flow rate of the low-pressure side refrigerant flowing through the coolant cooler 14, such as the rotation speed Nc of the compressor 21, can be employed for the physical quantity related to the cooling load of the blown air at the cooler core 16.

For example, the physical quantity related to the temperature difference (Two−Twi) obtained by subtracting the temperature Twi of the coolant flowing into the cooler core 16 from the temperature Two of the coolant flowing out of the cooler core 16, can be used as the physical quantity related to the cooling load of the blown air at the cooler core 16.

For example, the physical quantity related to the temperature difference (Tao−Tai) obtained by subtracting the temperature Tai of air flowing into the cooler core 16 from the temperature Tao of air flowing out of the cooler core 16, can be employed for the physical quantity related to the cooling load of the blown air at the cooler core 16.

In the present embodiment, when the flow rate of the coolant flowing through the cooler core 16 is increased, heat exchanging efficiency in the cooler core 16 can be improved by increasing the flow rate of the low-pressure side refrigerant flowing through the coolant cooler 14.

In the present embodiment, when the flow rate of the coolant flowing through the cooler core 16 is increased, the heat exchanging efficiency in the cooler core 16 can be improved by increasing the flow rate of the coolant flowing through the coolant heater 15.

In the present embodiment, when the flow rate of the coolant flowing through the cooler core 16 is increased, the heat exchanging efficiency in the cooler core 16 can be improved by increasing the flow rate of blown air flowing through the cooler core 16.

### Second Embodiment

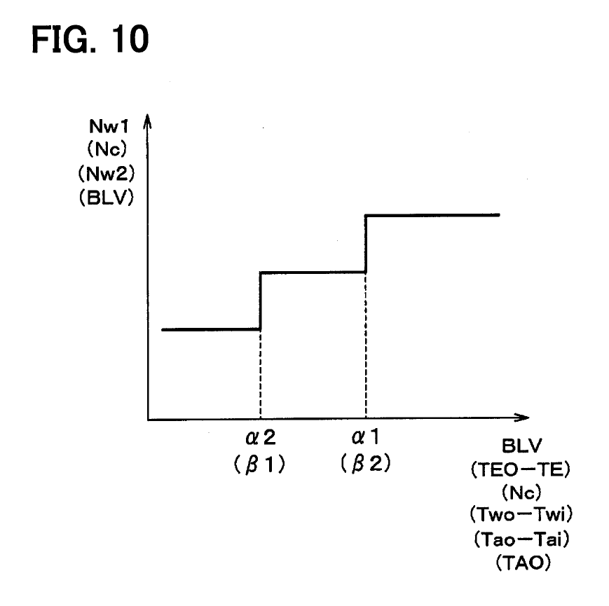

In the above-described embodiment, the rotation speed Nw1 of the first pump 11 is proportionally increased or decreased in accordance with the physical quantity (BLV, TEO−TE, Nc, Two−Twi, Tao−Tai, TAO) related to the cooling load of the blown air at the cooler core 16. In the present embodiment, as illustrated in FIG. 10, a rotation speed Nw1 of a first pump 11 is discontinuously increased or decreased in accordance with the physical quantity (BLV, TEO−TE, Nc, Two−Twi, Tao−Tai, TAO) related to a cooling load of blown air at a cooler core 16. In the present embodiment as well, similar operation and effects to the above embodiment can be produced.

Modifications to the above-described embodiments will be described below. The above embodiments can be appropriately combined together. The above embodiments can be variously modified, for example, as follows.

(1) In the above embodiments, various coolant circulation devices (heat medium circulation devices) in which the coolant absorbs heat by its sensible heat change may be provided instead of the cooler core 16. For example, a battery cooling unit for cooling a battery may be provided.

(2) In the above embodiments, a heat radiator for refrigerant that exchanges heat between the high-pressure side refrigerant in the refrigeration cycle 20 and the outside air to release the heat of the high-pressure side refrigerant into the outside air may be provided instead of the coolant heater 15.

(3) In the above embodiments, various temperature adjustment object devices (cooling object devices, heating object devices) that are temperature-adjusted (cooled or heated) by the coolant may be arranged in the first coolant circuit C1 and the second coolant circuit C2.

Furthermore, the first coolant circuit C1 and the second coolant circuit C2 may be connected through a changeover valve, and the changeover valve may switch between a case where the coolant suctioned into or discharged from the first pump 11 circulates, and a case where the coolant suctioned into or discharged from the second pump 12 circulates respectively through more than one heat medium circulation device arranged in the first coolant circuit C1 and the second coolant circuit C2.

(4) In the above embodiments, the coolant is used as the heat medium flowing through the cooler core 16. Alternatively, various media such as oil may be employed for the heat medium.

Nano fluid may be used as the heat medium. The nano fluid is a fluid, into which a nanoparticle whose particle diameter is in the order of nanometer is mixed. By mixing the nanoparticle into the heat medium, the following functions and effects can be produced in addition to functions and effects of reducing a freezing point like coolant (so-called antifreezing fluid) using ethylene glycol.

Specifically, functions and effects of improving heat conductivity at a particular temperature zone, functions and effects of increasing a heat capacity of the heat medium, an anticorrosive effect on metal piping, functions and effects of preventing deterioration of rubber piping, and functions and effects of increasing fluidity of the heat medium at extremely low-temperature can be produced.

These functions and effects variously change according to a particle configuration, a particle shape, and a compounding ratio of the nanoparticle, and additive materials.

Accordingly, the heat conductivity can be improved, and thus equivalent cooling efficiency can be achieved even by the smaller amount of the heat medium than the coolant using ethylene glycol.

Moreover, the heat capacity of the heat medium can be increased, and thus the cold storage heat amount of the heat medium itself (cold storage heat by sensible heat) can be increased.

By increasing the cold storage heat amount, cooling of devices and temperature adjustment of heating using the cold storage heat can be carried out for a certain period of time even in a state where the compressor 21 is not operated. As a result, the power of the vehicle heat management device 10 can be saved.

An aspect ratio of the nanoparticle may be equal to or higher than 50 to obtain sufficient heat conductivity. The aspect ratio is a shape index indicating a length/width ratio of the nanoparticle.

The particle containing any one of Au, Ag, Cu, and C can be employed for the nanoparticle. Specifically, for example, Au nanoparticle, Ag nanowire, carbon nanotube (CNT), graphene, graphite core-shell nanoparticle (particle body having a structure such as a carbon nanotube to surround the above atom), or Au nanoparticle containing CNT can be used as a constituent atom of the nanoparticle.

(5) In the refrigeration cycle 20 of the above embodiments, the fluorocarbon refrigerant is employed as the refrigerant. However, the type of refrigerant is not limited to this. For example, natural refrigerant such as carbon dioxide, or hydrocarbon system refrigerant may be used.

The refrigeration cycle 20 of the above embodiments is configured as a subcritical refrigeration cycle in which the pressure of the high-pressure side refrigerant does not exceed the critical pressure of the refrigerant. Alternatively, the refrigeration cycle 20 may be configured as a supercritical refrigeration cycle in which the pressure of the high-pressure side refrigerant exceeds the critical pressure of the refrigerant.

(6) In the above embodiments, the application of the vehicle heat management device 10 to a hybrid automobile has been illustrated. Alternatively, the vehicle heat management device 10 may be applied to, for example, an electric automobile that does not include an engine and obtains the driving force for vehicle traveling from the electric motor for traveling.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle heat management device applied to a refrigeration cycle, comprising:
a pump that suctions and discharges a heat medium;
a heat medium cooler that exchanges heat between the heat medium discharged by the pump and low-pressure side refrigerant in the refrigeration cycle to evaporate the low-pressure side refrigerant and to cool the heat medium;
a heat medium circulation device, wherein:
the heat medium, the heat of which is exchanged in the heat medium cooler flows through the heat medium circulation device; and
the heat medium absorbs heat by its sensible heat change in the heat medium circulation device; and
a heat medium flow control part that increases a flow rate of the heat medium flowing through the heat medium circulation device when an amount of the heat absorbed by the heat medium in the heat medium circulation device is determined to be larger than a predetermined amount of heat.

2. A vehicle heat management device applied to a refrigeration cycle, comprising:
a heat medium cooler that exchanges heat between low-pressure side refrigerant in the refrigeration cycle and a heat medium to evaporate the low-pressure side refrigerant and to cool the heat medium;
a heat medium circulation device, wherein:
the heat medium, the heat of which is exchanged in the heat medium cooler, flows through the heat medium circulation device; and
the heat medium absorbs heat by its sensible heat change in the heat medium circulation device; and
a heat medium flow control part that decreases a flow rate of the heat medium flowing through the heat medium circulation device when an amount of the heat absorbed by the heat medium in the heat medium circulation device is determined to be smaller than a predetermined amount of heat.

3. The vehicle heat management device according to claim 1, wherein:
the heat medium circulation device is an air cooler that exchanges heat between air blown out into a vehicle interior and the heat medium to cool the air; and
the heat medium flow control part controls the flow rate of the heat medium flowing through the heat medium circulation device in accordance with a physical quantity related to a cooling load of the air at the air cooler.

4. The vehicle heat management device according to claim 3, further comprising an air flow control part that controls a flow rate of the air flowing through the air cooler in accordance with the cooling load, wherein the heat medium flow control part uses a physical quantity related to the flow rate of the air flowing through the air cooler as the physical quantity related to the cooling load.

5. The vehicle heat management device according to claim 3, further comprising a refrigerant flow control part that controls a flow rate of the low-pressure side refrigerant flowing through the heat medium cooler in accordance with the cooling load, wherein the heat medium flow control part uses a physical quantity (Nc) related to the flow rate of the low-pressure side refrigerant flowing through the heat medium cooler as the physical quantity related to the cooling load.

6. The vehicle heat management device according to claim 3, wherein the heat medium flow control part uses a physical quantity related to a temperature difference obtained by subtracting a temperature of the heat medium flowing into the air cooler from a temperature of the heat medium flowing out of the air cooler as the physical quantity related to the cooling load.

7. The vehicle heat management device according to claim 3, wherein the heat medium flow control part uses a physical quantity related to a temperature difference obtained by subtracting a temperature of the air flowing into the air cooler from a temperature of the air flowing out of the air cooler as the physical quantity related to the cooling load.

8. The vehicle heat management device according to claim 1, further comprising a refrigerant flow control part that increases a flow rate of the low-pressure side refrigerant flowing through the heat medium cooler when the heat medium flow control part increases the flow rate of the heat medium flowing through the heat medium circulation device.

9. The vehicle heat management device according to claim 1, further comprising:
a refrigerant cooler that exchanges heat between high-pressure side refrigerant in the refrigeration cycle and another heat medium to cool the high-pressure side refrigerant; and
another heat medium flow control part that increases a flow rate of the another heat medium flowing through the refrigerant cooler when the heat medium flow control part increases the flow rate of the heat medium flowing through the heat medium circulation device.

10. The vehicle heat management device according to claim 1, wherein the heat medium circulation device is an air cooler that exchanges heat between air blown out into a vehicle interior and the heat medium to cool the air, the vehicle heat management device further comprising an air flow control part that increases a flow rate of the air flowing through the air cooler when the heat medium flow control part increases the flow rate of the heat medium flowing through the heat medium circulation device.

11. The vehicle heat management device according to claim 2, wherein:
the heat medium circulation device is an air cooler that exchanges heat between air blown out into a vehicle interior and the heat medium to cool the air; and
the heat medium flow control part controls the flow rate of the heat medium flowing through the heat medium circulation device in accordance with a physical quantity related to a cooling load of the air at the air cooler.

12. The vehicle heat management device according to claim 11, further comprising an air flow control part that controls a flow rate of the air flowing through the air cooler in accordance with the cooling load, wherein the heat medium flow control part uses a physical quantity related to the flow rate of the air flowing through the air cooler as the physical quantity related to the cooling load.

13. The vehicle heat management device according to claim 11, further comprising a refrigerant flow control part that controls a flow rate of the low-pressure side refrigerant flowing through the heat medium cooler in accordance with the cooling load, wherein the heat medium flow control part uses a physical quantity related to the flow rate of the low-pressure side refrigerant flowing through the heat medium cooler as the physical quantity related to the cooling load.

14. The vehicle heat management device according to claim 11, wherein the heat medium flow control part uses a physical quantity related to a temperature difference obtained by subtracting a temperature of the heat medium flowing into the air cooler from a temperature of the heat medium flowing out of the air cooler as the physical quantity related to the cooling load.

15. The vehicle heat management device according to claim 11, wherein the heat medium flow control part uses a physical quantity related to a temperature difference obtained by subtracting a temperature of the air flowing into the air cooler from a temperature of the air flowing out of the air cooler as the physical quantity related to the cooling load.
